(19) United States
(12) Patent Application Publication
(10) Pub. No.: US 2004/0129683 A1
(43) Pub. Date: Jul. 8, 2004

(54) Spark plug and method for manufacturing the same

(75) Inventors: Kazuyoshi Torii, Aichi (JP); Hideki Teramura, Mie (JP); Tomoaki Kato, Aichi (JP); Mamoru Musasa, Aichi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 10/695,796

(22) Filed: Oct. 30, 2003

(30) Foreign Application Priority Data
Nov. 1, 2002 (JP) 2002-320379

(51) Int. Cl. B23K 11/00

(52) U.S. Cl. 219/117.1

(57) ABSTRACT

A method for manufacturing a spark plug is disclosed. In first step S10, a chip 1 including a flange portion 1b and a protrusion 1a protruding from a first face 1c of the flange portion 1b is manufactured. In second step S20, a second face 1d of the flange portion 1b is tentatively joined, through resistance welding, to a joint face 32 (42) of the electrode base metal of at least either one of a center electrode 30 and a ground electrode 40, the joint face 32 (42) being located on the side toward a discharge gap. In third step S30, the flange portion 1b is laser-welded to the joint face 32 (42) such that a weld portion 3 extends to points on the second face 1d of the flange portion 1b, the points being located inward of corresponding intersections of the second face 1d of the flange portion 1b and imaginary extension lines of the side surface of the protrusion 1a.

### BACKGROUND OF THE INVENTION

1. Field of the Invention

The present invention relates to a spark plug and method for manufacturing the same.

2. Description of the Related Art

Japanese Patent Application Laid-Open (kokai) No. 2001-244042 will be referred to herein as Patent Document 1. Patent Document 1 describes a conventionally known spark plug. This spark plug includes a tubular metallic shell. A tubular insulator is fixed in the metallic shell so as to extend in the axial direction of the metallic shell and such that the opposite ends of the insulator protrude from corresponding opposite ends of the metallic shell. A center electrode extends in the axial direction of the metallic shell such that the distal end of the center electrode protrudes from the distal end of the insulator, and the rear end of the center electrode is fixed in the insulator. Meanwhile, one end of a ground electrode is fixed to the metallic shell, and the other end portion of the ground electrode, together with the center electrode, forms a discharge gap therebetween. Each of the center electrode and the ground electrode includes an electrode base metal, which is an Ni alloy or the like such as Inconel (registered trademark) 600, and a chip provided on the electrode base metal at a position for forming the discharge gap and formed of a spark erosion resistant material such as an Ir-containing Pt alloy.

The center electrode of this spark plug is manufactured as follows. First a chip is formed which includes a flange portion and a protrusion protruding from a first face of the flange portion. A second face of the chip opposite the protrusion is laser welded to a joint face of the electrode base metal located on the side toward the discharge gap, thereby forming the center electrode. At this time, a weld portion is formed so as to penetrate into the electrode base metal and the flange portion of the chip.

In this spark plug, the diameter of the flange portion of the chip is greater than that of the protrusion of the chip. Thus, as compared with the case of an ordinary columnar chip, a weld portion is formed over a wide range. Since a weld portion is formed so as to penetrate the flange portion and the electrode base metal, a reduction in the diameter of a weld zone can be prevented, which would otherwise result from spattering of the electrode base metal induced by laser welding. Thus, this spark plug can ensure the joining strength between the electrode base metal and the chip.

### PROBLEMS SOLVED BY THE INVENTION

However, Patent Document 1, which discloses the above-described conventional spark plug, merely specifies that the weld portion be present over a certain distance or more as measured inward from the outer circumference of the flange portion of the chip. Thus, depending on the chip shape, difficulty may be encountered in ensuring the joining strength between the electrode base metal and the chip. For example, in the case where an employed chip includes a flange portion and a columnar protrusion, and the diameter of the protrusion is relatively large, a weld portion is formed only in the vicinity of the outer circumference of the flange portion, and thus the weld portion is not present in a large area at a central part of the flange portion. In such a case, sufficient joining strength between the electrode base metal and the chip fails to be ensured, and difficulty is encountered in maintaining durability of the spark plug over long term use.

### SUMMARY OF THE INVENTION

The present invention has been accomplished in view of the above-mentioned problems of a conventional spark plug, and an object of the invention is to provide a spark plug whose joining strength between an electrode base metal and a chip is reliably ensured, as well as to provide a method for manufacturing the same.

The present invention provides a method for manufacturing a spark plug which comprises a tubular metallic shell, a tubular insulator extending in an axial direction of the metallic shell and fixed in the metallic shell with opposite ends of the insulator protruding from corresponding opposite ends of the metallic shell, a center electrode extending in the axial direction of the metallic shell and fixed in the insulator with a distal end of the center electrode protruding from a distal end of the insulator and with a rear end of the center electrode fixed in the insulator, and a ground electrode with one end of the ground electrode fixed to the metallic shell and with the other end portion of the ground electrode and the center electrode forming a discharge gap therebetween, and in which at least either one of the center electrode and the ground electrode comprises an electrode base metal and a chip provided on the electrode base metal at a position for forming the discharge gap and formed of a spark erosion resistant material, the method comprising:

a first step for providing chip comprising a flange portion and a protrusion protruding from a first face of the flange portion;

a second step for tentatively joining, through resistance welding, a second face of the flange portion opposite the protrusion to a joint face of the electrode base metal of at least either one of the center electrode and the ground electrode, the joint face being located on a side toward the discharge gap; and

a third step for laser-welding the flange portion to the joint face such that a weld portion is formed between the electrode base metal and the chip to reach points on the second face of the flange portion, the points being located inward of corresponding intersections of the second face of the flange portion and imaginary extension lines of generatrices (generating lines) of a side surface of the protrusion.

According to the method for manufacturing a spark plug of the present invention, in the first step, the chip comprising a flange portion and a protrusion protruding from a first face of the flange portion is prepared. Next, in the second step, the second face of the flange portion is tentatively joined, through resistance welding, to the joint face of the electrode base metal of at least either one of the center electrode and the ground electrode, the joint face being located on the side toward the discharge gap. In the third step, the flange portion is laser-welded to the joint face of the electrode base metal. The laser welding is performed such that the weld portion is formed between the electrode base metal and the chip to reach points on the second face of the flange portion, the points being inward of corresponding intersections of the second face of the flange portion and imaginary extension lines of generatrices of the side surface of the protrusion. In the case where the protrusion of the chip assumes the shape of a cylinder, a prism, a circular cone, a pyramid, a frustum of a cone, or a frustum of a pyramid, the generatrices are lines extending on the side surface of the protrusion and capable of forming a common plane together with the axis of the protrusion. Thus, a problem can be prevented in that the weld portion is not present in a large area at a central part of the flange portion. Therefore, the flange portion is reliably joined to the joint face of the electrode base metal.

Thus, the method for manufacturing a spark plug of the present invention can ensure sufficient joining strength between the electrode base metal and the chip.

The method for manufacturing a spark plug of the present invention allows the joint face to be located on the electrode base metal of the ground electrode on the side toward the discharge gap. In other words, the method can be applied not only to the case of welding the chip to the electrode base metal of the center electrode, but also to the case of welding the chip to the electrode base metal of the ground electrode, which requires higher welding strength.

Preferably, in the method for manufacturing a spark plug of the present invention, when D represents the maximum distance between the intersections of the second face of the flange portion and imaginary extension lines of generatrices of the side surface of the protrusion, the weld portion is present so as to extend to a distance D/5 or more inward of the intersections as measured on the second face. The results of a test conducted by the present inventors have revealed that this feature ensures reliable joining of the flange portion and the joint face of the electrode base metal.

Preferably, in the method for manufacturing a spark plug of the present invention, in the first step, a plate-like intermediate member is provided having a melting point or linear expansion coefficient falling between that of the electrode base metal and that of the chip, and having a face larger than the second face of the flange portion; and in the second step, the intermediate member is provided between the joint face and the chip. During the course of laser irradiation, employment of such an intermediate member provides good compatibility between the intermediate member and the electrode base metal and between the intermediate member and the chip, and also reduces the difference in thermal stress that is induced between the intermediate member and the electrode base metal and between the intermediate member and the chip. Therefore, separation hardly arises between the intermediate member and the electrode base metal and between the intermediate member and the chip.

Preferably, in the second step, after the intermediate member is tentatively joined to the joint face through resistance welding, the second face of the flange portion is tentatively joined to the intermediate member through resistance welding. This prevents movement of the intermediate member and the chip during the course of laser welding, thereby reliably welding the electrode base metal and the chip.

Preferably, in the method for manufacturing a spark plug of the present invention, when the joint face is located on the electrode base metal of the ground electrode on the side toward the discharge gap, the chip is welded to the ground electrode while the ground electrode is bent away from the distal end of the center electrode. Since this avoids imposition of restrictions on the angle of laser irradiation, the chip can be welded to the ground electrode at the optimum angle of laser irradiation.

The present invention provides a spark plug comprising a tubular metallic shell, a tubular insulator extending in an axial direction of the metallic shell and fixed in the metallic shell with opposite ends of the insulator protruding from corresponding opposite ends of the metallic shell, a center electrode extending in the axial direction of the metallic shell and fixed in the insulator with a distal end of the center electrode protruding from a distal end of the insulator and with a rear end of the center electrode fixed in the insulator, and a ground electrode with one end of the ground electrode fixed to the metallic shell and with the other end portion of the ground electrode and the center electrode forming a discharge gap therebetween, at least either one of the center electrode and the ground electrode comprising an electrode base metal and a chip provided on the electrode base metal at a position for forming the discharge gap and formed of a spark erosion resistant material,

wherein the chip comprises a flange portion and a protrusion protruding from a first face of the flange portion; a second face of the flange portion opposite the protrusion is tentatively joined, through resistance welding, to a joint face of the electrode base metal of at least either one of the center electrode and the ground electrode, the joint face being located on a side toward the discharge gap; and the flange portion is laser-welded to the joint face such that a weld portion is formed between the electrode base metal and the chip to reach points on the second face of the flange portion, the points being located inward of corresponding intersections of the second face of the flange portion and imaginary extension lines of generatrices of a side surface of the protrusion.

In the spark plug of the present invention, the chip comprises the flange portion and the protrusion, and laser welding is performed such that the weld portion is formed between the electrode base metal and the chip to reach points on the second face of the flange portion, the points being located inward of corresponding intersections of the second face of the flange portion and imaginary extension lines of generatrices of the side surface of the protrusion. Thus, a problem can be prevented in that the weld portion is not present in a large area at a central part of the flange portion. Therefore, the flange portion is reliably joined to the joint face of the electrode base metal, whereby the joining strength between the electrode base metal and the chip can be ensured, and the durability of the spark plug can be maintained over long term use.

Preferably, the weld portion contains components of the chip in an amount of 20% by mass to 80% by mass. According to the results of a test conducted by the present inventors, when the weld portion contains components of the chip in an amount less than 20% by mass or in excess of 80% by mass, the electrode base metal and the chip are unlikely to be compatible with each other, and a great difference arises in thermal stress that is induced between the electrode base metal and the chip, potentially resulting in a failure to ensure the joining strength between the electrode base metal and the chip. By contrast, when the weld portion contains components of the chip in an amount of 20% by mass to 80% by mass, the electrode base metal and the chip are compatible with each other, and the difference in thermal stress that is induced between the electrode base metal and the chip is small, whereby the joining strength between the electrode base metal and the chip can be readily ensured.

Particularly preferably, the weld portion contains components of the chip in an amount of 30% by mass to 60% by mass. This reliably ensures the joining strength between the electrode base metal and the chip.

### BRIEF DESCRIPTION OF THE DRAWINGS

FIG. 1 relates to an embodiment of the invention, and shows a process diagram of a method for manufacturing a spark plug;

FIG. 2 relates to an embodiment of the invention, and shows a side view of a chip;

FIG. 3 relates to an embodiment of the invention, and shows a side view of an intermediate member in the process of resistance welding;

FIG. 4 relates to an embodiment of the invention, and shows a side view of the chip and the intermediate member in the process of resistance welding;

FIG. 5 relates to an embodiment of the invention, and shows a side view of the chip and the intermediate member in the process of laser welding;

FIG. 6 relates to an embodiment of the invention, and shows a center electrode or a ground electrode as viewed after laser welding;

FIG. 7 relates to an embodiment of the invention, and shows a partially enlarged side view of a spark plug;

FIG. 8 relates to an embodiment of the invention, and shows a partially enlarged side view of the spark plug;

FIG. 9 relates to an embodiment of the invention, and shows a partially sectional side view of the spark plug; and

FIGS. 10(a)-10(c) relate to an embodiment of the invention, and show side views of other chips.

Reference numerals are used to identify items shown in the drawings as follows:

60: metallic shell

62: insulator

30: center electrode

40: ground electrode

1: chip

1a, 71a, 72a, 73a: protrusion

1b, 71b, 72b, 73b: flange portion

2: intermediate member

3: weld portion

32, 42: joint face

S10: first step

S20: second step

S30: third step

### DETAILED DESCRIPTION OF THE PREFERRED EMBODIMENT

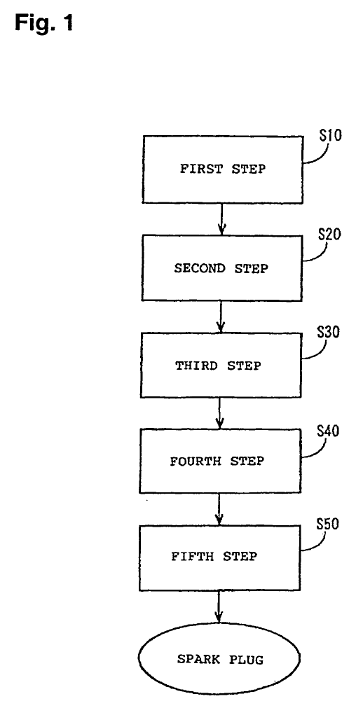

A spark plug and a method for manufacturing the same according to an embodiment of the present invention and a test for the spark plug and the method will be described with reference to FIGS. 1 to 10. However, the present invention should not be construed as being limited thereto.

### Embodiment

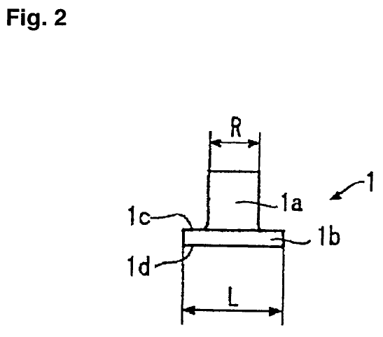

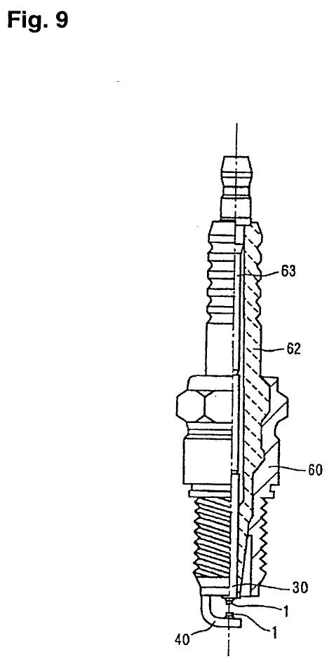

First, as shown in FIG. 1, in first step S10, a chip 1 is manufactured from a spark erosion resistant material, which is an Ir alloy containing at least any one of 1% by mass to 20% by mass Rh, 1% by mass to 10% by mass Pt, 1% by mass to 5% by mass Y₂O₃, and 1% by mass to 20% by mass Ni, or a Pt alloy containing at least any one of 20% by mass to 60% by mass Rh, 10% by mass to 40% by mass Ir, and 1% by mass to 20% by mass Ni. When the chip 1 is to be attached to both of a center electrode 30 and a ground electrode 40 (see FIG. 9), either the chips 1 of the same material or the chips 1 of different materials may be used. As shown in FIG. 2, the chip 1 includes a flange portion 1b and a protrusion 1a protruding from a first face 1c of the flange portion 1b. The flange portion 1b assumes the shape of a disk and has a diameter L of 1 mm and a thickness of 0.2 mm. The protrusion 1a assumes a cylindrical shape and has a diameter R of 0.6 mm and a thickness of 0.5 mm.

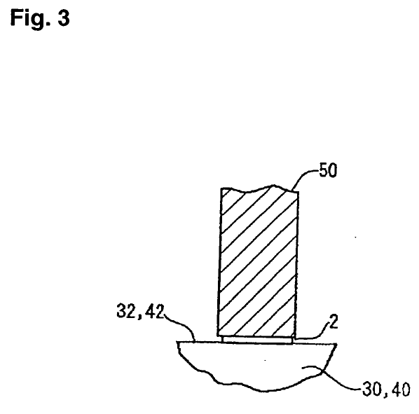

As shown in FIG. 3, an intermediate member 2 is manufactured from an Ir alloy containing 40% by mass Ni. The intermediate member 2 assumes the shape of a disk and has a diameter L of 1.2 mm and a thickness of 0.2 mm.

In second step S20 shown in FIG. 1, as shown in FIG. 3, the intermediate member 2 is tentatively joined to the center electrode 30 through resistance welding. The center electrode 30 uses Inconel (registered trademark) 600, which is an Ni alloy, as an electrode base metal and has a diameter of 2.5 mm. For the tentative joining, first, the intermediate member 2 is placed on a joint face 32 of the center electrode 30, the joint face 32 facing a discharge gap. Then, a first electric resistance welding machine 50 is applied to the intermediate member 2. A predetermined current is applied to the first electric resistance welding machine 50 while a predetermined pressure is applied to the intermediate member 2, thereby tentatively joining the intermediate member 2 to the center electrode 30 through resistance welding.

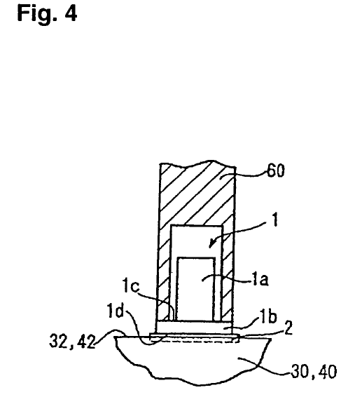

Subsequently, as shown in FIG. 4, the flange portion 1b of the chip 1 is placed on the intermediate member 2, which is tentatively joined to the center electrode 30. A second electric resistance welding machine 60 is applied to the first face 1c of the flange portion 1b. A predetermined current is applied to the second electric resistance welding machine 60 while a predetermined pressure is applied to the first face 1c. Notably, the second electric resistance welding machine 60 has a structure so as not to contact the distal end face of the chip 1, whereby the distal end face of the chip 1 is free of any influence of the resistance welding. Thus, a second face 1d of the flange portion 1b is tentatively joined to the intermediate member 2 through resistance welding, whereby the intermediate member 2 and the chip 1 are tentatively joined to the center electrode 30.

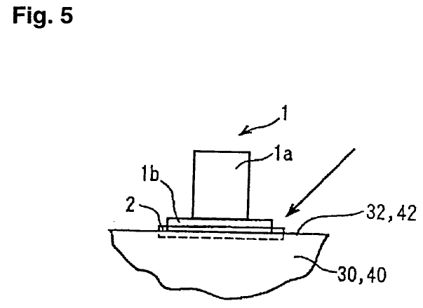

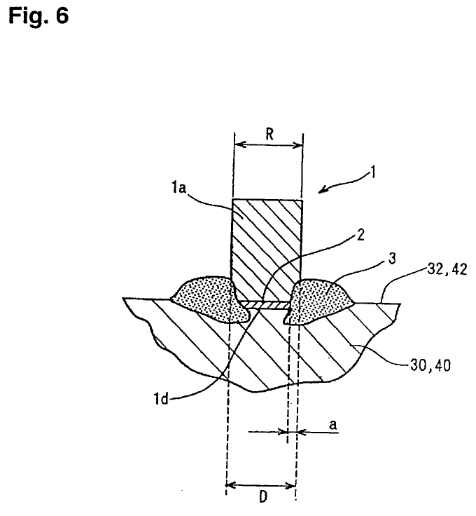

Next, in third step S30 shown in FIG. 1, as represented by the arrow of FIG. 5, a laser beam is irradiated so as to weld the flange portion 1b of the chip 1 to the joint face 32 of the center electrode 30. The laser welding is performed such that, as shown in FIG. 6, when D represents the maximum distance between the intersections of the second face 1d of the flange portion 1b and imaginary extension lines of generatrices extending on the side surface of the cylindrical protrusion 1a and capable of forming a common plane together with the axis of the protrusion 1a, and a represents the distance of the deepest point of a weld portion 3 as measured on the second face 1d from the intersection, a is D/5 or more. This allows the weld portion 3 to contain components of the chip 1 in an amount of 30% by mass to 60% by mass. Notably, in the present embodiment, D is equal to the diameter R of the protrusion 1.

Subsequently, as shown in FIG. 9, the center electrode 30 is fitted into an insulator 62 such that the distal end of the center electrode 30 protrudes from the insulator 62; and a terminal 63 is inserted into the insulator 62 to be located on the rear side of the center electrode 30. The resultant assembly is fitted into a metallic shell 60.

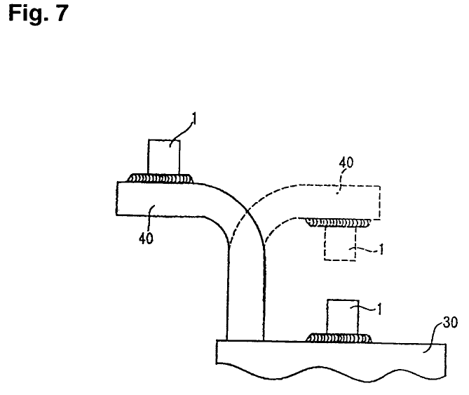

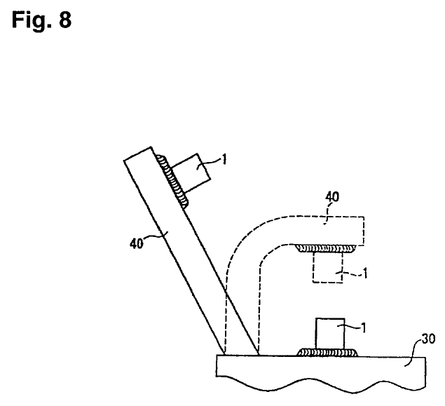

In fourth step S40 shown in FIG. 1, as shown in FIG. 9, the ground electrode 40, which is welded to the metallic shell 60 beforehand, is prepared. As in the case of the center electrode 30, the ground electrode 40 uses Inconel (registered trademark) 600, which is an Ni alloy, as an electrode base metal and has a width of 2.5 mm. As shown in FIG. 7 or 8, the ground electrode 40 is bent away from the distal end of the center electrode 30.

As shown in FIG. 3, the intermediate member 2 is tentatively joined to the ground electrode 40 through resistance welding. For the tentative joining, first, the intermediate member 2 is placed on a joint face 42 of the ground electrode 40, the joint face 42 facing the discharge gap. Then, the first electric resistance welding machine 50 is applied to the intermediate member 2. A predetermined current is applied to the first electric resistance welding machine 50 while a predetermined pressure is applied to the intermediate member 2, thereby tentatively joining the intermediate member 2 to the ground electrode 40 through resistance welding.

Subsequently, as shown in FIG. 4, the flange portion 1b of the chip 1 is placed on the intermediate member 2, which is tentatively joined to the ground electrode 40. The second electric resistance welding machine 60 is applied to the first face 1c of the flange portion 1b. A predetermined current is applied to the second electric resistance welding machine 60 while a predetermined pressure is applied to the first face 1c, thereby tentatively joining the second face 1d of the flange portion 1b to the intermediate member 2 through resistance welding. Thus, the intermediate member 2 and the chip 1 are tentatively joined to the ground electrode 40.

Next, in fifth step S50 shown in FIG. 1, as represented by the arrow of FIG. 5, a laser beam is irradiated so as to weld the flange portion 1b of the chip 1 to the joint face 42 of the ground electrode 40. The laser welding is performed such that, as shown in FIG. 6, when D represents the maximum distance between the intersections of the second face 1d of the flange portion 1b and imaginary extension lines of generatrices extending on the side surface of the cylindrical protrusion 1a and capable of forming a common plane together with the axis of the protrusion 1a, and a represents the distance of the deepest point of the weld portion 3 as measured on the second face 1d from the intersection, a is D/5 or more. This allows the weld portion 3 to contain components of the chip 1 in an amount of 30% by mass to 60% by mass. Notably, in the present embodiment, D is equal to the diameter R of the protrusion 1.

Subsequently, as shown in FIGS. 7 and 8, the end portion of the electrode base metal of the ground electrode 40 to which the chip 1 has been welded is bent back toward the center electrode 30. Thus, the spark plug shown in FIG. 9 is obtained.

According to the method for manufacturing a spark plug of the present embodiment, in relation to the maximum distance D between the intersections of the second face 1d of the flange portion 1b and imaginary extension lines of generatrices extending on the side surface of the cylindrical protrusion 1a and capable of forming a common plane together with the axis of the protrusion 1a, the weld portion 3 is present so as to extend to a distance D/5 or more inward of the intersections as measured on the second face. Thus, a problem can be prevented in that the weld portion 3 is not present in a large area at a central part of the flange portion 1b. Therefore, the flange portion 1b is reliably joined to the joint face 32 (42) of the electrode base metal.

According to the method for manufacturing a spark plug of the present embodiment, the intermediate member 2 has a melting point and a linear expansion coefficient falling between those of the electrode base metal and those of the chip 1; thus, during the course of laser irradiation, good compatibility is established between the intermediate member 2 and the electrode base metal and between the intermediate member 2 and the chip 1, and the difference in thermal stress that is induced between the intermediate member 2 and the electrode base metal and between the intermediate member 2 and the chip 1 can be reduced. Therefore, separation hardly arises between the intermediate member 2 and the electrode base metal and between the intermediate member 2 and the chip 1.

According to the method for manufacturing a spark plug of the present embodiment, after the intermediate member 2 is tentatively joined to the joint face 32 (42) through resistance welding, the second face 1d of the flange portion 1b is tentatively joined to the intermediate member 2 through resistance welding; thus, movement of the intermediate member 2 and the chip 1 during the course of laser welding can be prevented, whereby the electrode base metal and the chip 1 can be reliably welded together.

Therefore, the method for manufacturing a spark plug of the present embodiment can reliably ensure the joining strength between the electrode base metal and the chip 1.

According to the method for manufacturing a spark plug of the present embodiment, the chip 1 is welded to the ground electrode 40 while the ground electrode 40 is bent away from the distal end of the center electrode 30. Since this avoids imposition of restrictions on the angle of laser irradiation, the chip 1 can be welded to the ground electrode 40 at the optimum angle of laser irradiation.

As shown in FIG. 9, the thus-obtained spark plug includes the tubular metallic shell 60. The tubular insulator 62 is fixed in the metallic shell 60 so as to extend in the axial direction of the metallic shell 60 and such that the opposite ends of the insulator 62 protrude from corresponding opposite ends of the metallic shell 60. The center electrode 30 extends in the axial direction of the metallic shell 60 such that the distal end of the center electrode 30 protrudes from the distal end of the insulator 62, and the rear end of the center electrode 30 is fixed in the insulator 62. Meanwhile, one end of the ground electrode 40 is fixed to the metallic shell 60, and the other end portion of the ground electrode 40, together with the center electrode 30, forms a discharge gap therebetween. The chips 1 are provided on the center electrode 30 and the ground electrode 40, respectively, in opposition to each other while maintaining a discharge gap therebetween.

In this spark plug, the chip 1 includes the flange portion 1b and the protrusion 1a. The chip 1 is laser-welded to the electrode base metal such that the weld portion 3 is formed between the electrode base metal and the chip 1 and reaches points on the second face 1d of the flange portion 1b, the points being located inward of corresponding intersections of the second face 1d of the flange portion 1b and imaginary extension lines of generatrices extending on the side surface of the cylindrical protrusion 1a and capable of forming a common plane together with the axis of the protrusion 1a. Thus, a problem can be prevented in that the weld portion 3 is not present in a large area at a central part of the flange portion 1b. Therefore, the flange portion 1b is reliably joined to the joint face 32 (42) of the electrode base metal, whereby the joining strength between the electrode base metal and the chip 1 can be ensured, and the durability of the spark plug can be maintained over long term use.

In this spark plug, since the weld portion 3 contains components of the chip 1 in an amount of 30% by mass to 60% by mass, the electrode base metal and the chip 1 are compatible with each other, and the difference in thermal stress to be induced between the electrode base metal and the chip 1 is small, whereby the joining strength between the electrode base metal and the chip 1 can be readily ensured.

Evaluation

A test for verifying the effect of the method for manufacturing a spark plug of the present embodiment was carried out. First, the chips 1 and the intermediate members 2 were manufactured using alloys similar to those of the embodiment and in shapes similar to those of the embodiment. Four types of the chips 1 were manufactured as follows: as shown in FIG. 6, when D represents the maximum distance (equal to the diameter R of the protrusion 1; hereinafter called the “diameter R of the protrusion 1”) between intersections of the second face 1d of the flange portion 1b and imaginary extension lines of generatrices extending on the side surface of the cylindrical protrusion 1a and capable of forming a common plane together with the axis of the protrusion 1a, D is 0.6 mm, 0.8 mm, 1.0 mm, and 1.2 mm. The diameter of the flange portion 1b is 0.4 mm greater than the diameter R of the protrusion 1 of each type.

Each of the chips 1 was laser-welded, in a manner similar to that of the embodiment, to an electrode base metal that was an alloy similar to that used to form the center electrode 30 and the ground electrode 40 of the embodiment. The test was conducted for the following two cases: the intermediate member 2 was used as in the case of the embodiment; and, without use of the intermediate member 2, the chip 1 was directly laser-welded to the electrode base metal.

The test conditions are described below. The chip 1 was laser-welded to the electrode base metal as follows: when a represents the distance of the deepest point (hereinafter, called “penetration”) of the weld portion 3 as measured on the second face 1d from the intersection between the second face 1d of the flange portion 1b and an imaginary extension line of a generatrix of the side surface of the protrusion 1a, the weld portion 3 of a predetermined penetration a was formed for each type of the chip 1. The weld portion was heated for two minutes by use of a burner and was then allowed to cool at the room temperature for one minute. After this cycle was repeated for 50 hours, the weld portion was examined for the length of oxide scale thus formed. The oxide scale refers to a defect induced by a difference in thermal stress; specifically, a crack observed on the cross section of the chip 1 or exfoliation of the chip 1. The burner temperature was 900° C. and 950° C.

Tables 1 to 4 show the test results. Table 1 shows the test results for a diameter R of the protrusion 1 of 0.6 mm; Table 2 shows the test results for a diameter R of the protrusion 1 of 0.8 mm; Table 3 shows the test results for a diameter R of the protrusion 1 of 1.0 mm; and Table 4 shows the test results for a diameter R of the protrusion 1 of 1.2 mm. In Tables 1 to 4, “o” indicates that the length b of an oxide scale was less than L/3, where L is the diameter of the flange portion 1b; “Δ” indicates that the length b of an oxide scale was equal to or greater than L/3 and less than L/2; and “×” indicates that the length b of an oxide scale was equal to or greater than L/2.

TABLE 1
D = 0.6 mm

| | | |
|---|---|---|
| Intermediate | Temperature | Penetration a (mm) |

| member | (° C.) | 0.10 | 0.12 | 0.15 | 0.18 |
|---|---|---|---|---|---|
| Absent | 900 | x | ∘ | ∘ | ∘ |
| | 950 | x | ∘ | ∘ | ∘ |
| Present | 900 | Δ | ∘ | ∘ | ∘ |
| | 950 | x | ∘ | ∘ | ∘ |

TABLE 2
D = 0.8 mm

| | | |
|---|---|---|
| Intermediate | Temperature | Penetration a (mm) |

| member | (° C.) | 0.10 | 0.13 | 0.16 | 0.20 |
|---|---|---|---|---|---|
| Absent | 900 | x | Δ | ∘ | ∘ |
| | 950 | x | x | ∘ | ∘ |
| Present | 900 | Δ | Δ | ∘ | ∘ |
| | 950 | x | Δ | ∘ | ∘ |

TABLE 3
D = 1.0 mm

| | | |
|---|---|---|
| Intermediate | Temperature | Penetration a (mm) |

| member | (° C.) | 0.10 | 0.15 | 0.20 | 0.25 |
|---|---|---|---|---|---|
| Absent | 900 | x | x | Δ | ∘ |
| | 950 | x | x | ∘ | ∘ |
| Present | 900 | x | Δ | ∘ | ∘ |
| | 950 | x | x | ∘ | ∘ |

TABLE 4
D = 1.2 mm

| | | |
|---|---|---|
| Intermediate | Temperature | Penetration a (mm) |

| member | (° C.) | 0.10 | 0.15 | 0.20 | 0.25 |
|---|---|---|---|---|---|
| Absent | 900 | x | x | Δ | ∘ |
| | 950 | x | x | x | ∘ |
| Present | 900 | x | Δ | Δ | ∘ |
| | 950 | x | x | x | ∘ |

As is apparent from Tables 1 to 4, when the penetration a was equal to or greater than D/5, all of the test results were evaluated as “o,” indicating that the length b of a scale was less than L/3. The test results reveal that, when the penetration a is equal to or greater than D/5, the joining strength between the electrode base metal and the chip 1 can be reliably ensured.

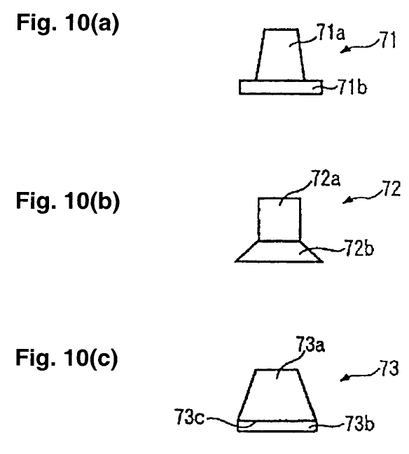

The manufacturing method of the embodiment can employ chips in various shapes; for example, chips 71 to 73 shown in FIGS. 10(a) to 10(c). In the case of the chip 71 shown in FIG. 10(a), a protrusion 71a has a taper surface. In the case of the chip 72 shown in FIG. 10(b), a flange portion 72b has a taper surface. In the case of the chip 73 shown in FIG. 10(c), a protrusion 73a has a taper surface, and the diameter of a bottom surface 73c of the protrusion 73a is equal to that of the flange portion 72b. Even when these chips 71 to 73 are used, the effect of the present invention can be obtained.

According to the manufacturing method of the embodiment, both of the protrusion and the flange portion assume a circular shape. However, the present invention is not limited thereto. A polygonal (e.g., triangular or quadrangular) chip may be used. Also, the protrusion and the flange portion do not necessarily assume the same shape.

According to the manufacturing method of the embodiment, the center electrode and the ground electrode use Inconel (registered trademark) as an electrode base metal. However, the present invention is not limited thereto. The electrode base metal may be, for example, Ni, an Ni alloy, Fe, or an Fe alloy.

It should further be apparent to those skilled in the art that various changes in form and detail of the invention as shown and described above may be made. It is intended that such changes be included within the spirit and scope of the claims appended hereto.

This application is based on Japanese Patent Application No. 2002-320379, filed Nov. 1, 2002, incorporated herein by reference in its entirety.

What is claimed is:

1. A method for manufacturing a spark plug which comprises a tubular metallic shell, a tubular insulator extending in an axial direction of the metallic shell and fixed in the metallic shell with opposite ends of the insulator protruding from corresponding opposite ends of the metallic shell, a center electrode extending in the axial direction of the metallic shell and fixed in the insulator with a distal end of the center electrode protruding from a distal end of the insulator and with a rear end of the center electrode fixed in the insulator, and a ground electrode with one end of the ground electrode fixed to the metallic shell and with the other end portion of the ground electrode and the center electrode forming a discharge gap therebetween, and in which at least one of the center electrode and the ground electrode comprises an electrode base metal and a chip provided on the electrode base metal at a position for forming the discharge gap and formed of a spark erosion resistant material, the method comprising:
(1) providing a chip comprising a flange portion and a protrusion protruding from a first face of the flange portion;
(2) tentatively joining, through resistance welding, a second face of the flange portion opposite the protrusion to a joint face of the electrode base metal of at least either one of the center electrode and the ground electrode, the joint face being located on a side toward the discharge gap; and
(3) laser-welding the flange portion to the joint face such that a weld portion is formed between the electrode base metal and the chip to reach points on the second face of the flange portion, the points being located inward of corresponding intersections of the second face of the flange portion and imaginary extension lines of generatrices of a side surface of the protrusion.

2. The method for manufacturing a spark plug as claimed in claim 1, wherein the joint face is located on the electrode base metal of the ground electrode on a side toward the discharge gap.

3. The method for manufacturing a spark plug as claimed in claim 2, wherein, when D represents a maximum distance between the intersections, the weld portion is present so as to extend to a distance D/5 or more inward of the intersections as measured on the second face.

4. The method for manufacturing a spark plug as claimed in claim 1, which comprises providing in step (1) a plate-like intermediate member having at least one of a melting point and linear expansion coefficient falling between that of the electrode base metal and that of the chip, and having a face larger than the second face of the flange portion; and
in step, (2), providing the intermediate member between the joint face and the chip.

5. The method for manufacturing a spark plug as claimed in claim 4, which comprises, in step (2), after the intermediate member is tentatively joined to the joint face through resistance welding, tentatively joining the second face of the flange portion to the intermediate member through resistance welding.

6. The method for manufacturing a spark plug as claimed in claim 1, which comprises locating the joint face on the electrode base metal of the ground electrode on a side toward the discharge gap, and welding the chip to the ground electrode while the ground electrode is bent away from the distal end of the center electrode.

7. A spark plug comprising a tubular metallic shell, a tubular insulator extending in an axial direction of the metallic shell and fixed in the metallic shell with opposite ends of the insulator protruding from corresponding opposite ends of the metallic shell, a center electrode extending in the axial direction of the metallic shell and fixed in the insulator with a distal end of the center electrode protruding from a distal end of the insulator and with a rear end of the center electrode fixed in the insulator, and a ground electrode with one end of the ground electrode fixed to the metallic shell and with the other end portion of the ground electrode and the center electrode forming a discharge gap therebetween, at least one of the center electrode and the ground electrode comprising an electrode base metal and a chip provided on the electrode base metal at a position for forming the discharge gap and formed of a spark erosion resistant material,
wherein the chip comprises a flange portion and a protrusion protruding from a first face of the flange portion; a second face of the flange portion opposite the protrusion is tentatively joined, through resistance welding, to a joint face of the electrode base metal of at least either one of the center electrode and the ground electrode, the joint face being located on a side toward the discharge gap; and the flange portion is laser-welded to the joint face such that a weld portion is formed between the electrode base metal and the chip to reach points on the second face of the flange portion, the points being located inward of corresponding intersections of the second face of the flange portion and imaginary extension lines of generatrices of a side surface of the protrusion.

8. The spark plug as claimed in claim 7, wherein the weld portion contains components of the chip in an amount in the range of from 20% by mass to 80% by mass.

9. The spark plug as claimed in claim 8, wherein the weld portion contains components of the chip in an amount in the range of from 30% by mass to 60% by mass.
